(19) United States
(12) Patent Application Publication
(10) Pub. No.: US 2016/0100135 A1
(43) Pub. Date: Apr. 7, 2016

(54) METHOD OF MONITORING AND CONTROLLING DEWATERING OF OIL SANDS TAILINGS

(71) Applicant: SYNCRUDE CANADA LTD. in trust for the owners of the Syncrude Project, as such owners exist now and, Fort McMurray (CA)

(72) Inventors: RANDY MIKULA, Edmonton (CA); BARRY BARA, Edmonton (CA); JAMES LORENTZ, Fort McMurray (CA); RICHARD LAHAIE, Canmore (CA)

(21) Appl. No.: 14/873,065

(22) Filed: Oct. 1, 2015

Related U.S. Application Data
(60) Provisional application No. 62/058,751, filed on Oct. 2, 2014.

(51) Int. Cl. H04N 7/18; C02F 1/56

(52) U.S. Cl. CPC H04N 7/183; C02F 1/56; C02F 2103/10

(57) ABSTRACT

A method for monitoring dewatering of flocculated oil sands tailings involves positioning an image capture device in a flow of flocculated oil sands tailing through a pipeline for acquiring images of the flocculated oil sands tailings; collecting the images of the flocculated oil sands tailings; and analyzing the one or more images to ensure production of optimum floc structures for maximum oil sands fine tailings dewatering.

### FIELD OF THE INVENTION

The present invention relates generally to the field of oil sands processing, particularly to a method of monitoring and controlling dewatering of oil sands tailings.

### BACKGROUND OF THE INVENTION

Oil sand deposits such as those found in the Athabasca Region of Alberta, Canada, generally comprise water-wet sand grains held together by a matrix of viscous heavy oil or bitumen. Bitumen is a complex and viscous mixture of large or heavy hydrocarbon molecules which contain a significant amount of sulfur, nitrogen and oxygen. Oil sands processing involves extraction and froth treatment to produce diluted bitumen which is further processed to produce synthetic crude oil and other valuable commodities. The extraction of bitumen from sand using hot water processes yields large volumes of fine tailings composed of fine silts, clays, residual bitumen and water. Mineral fractions with a particle diameter less than 44 microns are referred to as “fines.” These fines are typically clay mineral suspensions, predominantly kaolinite and illite. The fine tailings suspension is typically between 55 and 85% water and/or 15 to 45% fine particles by mass. Dewatering of fine tailings occurs very slowly.

Generally, the fine tailings are discharged into a storage pond for settling and dewatering. When first discharged in the pond, the very low density material is referred to as thin fine tailings. After a few years, when the fine tailings have reached a solids content of about 30-35 wt %, they are referred to as fluid fine tailings (FFT) and sometimes mature fine tailings (MFT), which still behave as a fluid-like colloidal suspension. The fact that mature fine tailings behave as a fluid and have very slow consolidation rates significantly limits options to reclaim tailings ponds.

Efforts have been increasing to reduce the ponds, as by speeding dewatering of FFT. These efforts focus on removing FFT from the ponds, as by dredging, and performing one or more of mechanical, chemical or electrical processes followed by placement of the partially dewatered tailings to form a landform. One such process involves flocculating FFT using conventional flocculating agents. The flocculated solids may then be removed from the water by centrifuging, filtering, or settling, for example, in a thickener or a tailings deposition site. At optimum flocculant dosage, the effectiveness of these processes is maximized, leading to rapid filtration rate, low cake moisture, and low solids levels in the filtrate/centrate. Too little or too much flocculant prevents the filtration, centrifuging or settling effectiveness being at the maximum. Further, too much flocculant is wasteful of chemicals, and at the huge volumes of tailings involved in an extraction plant, this could represent serious economic cost.

Typical analysis techniques provide off-line analysis or tapping of relatively small and possibly poorly representative samples. These are often difficult to correlate to on line process conditions from the resultant data because of the time lag in obtaining data. An in-line analysis method would be desirable to provide faster and better feedback for adjusting process control parameters related to flocculation.

### SUMMARY OF THE INVENTION

The current application is directed to a method of monitoring and controlling dewatering of oil sands tailings. It was surprisingly discovered that by using the process of the present invention, one or more of the following benefits may be realized:

(1) Proper mixing of the oil sands tailings and flocculant may be readily monitored in-line to ensure that the flocculated oil sands tailings exhibit the desired properties for successful dewatering. In-line analysis provides faster and better feedback for adjusting process control parameters related to flocculation.

(2) Images of the flocculated oil sands tailings are captured and analyzed to ensure production of optimum floc structures for maximum oil sands tailings dewatering. The degree of flocculation can be calculated from the images, and is correlated with dewatering capability.

(3) Mixing tank pressure as measured by pressure sensors may be used in conjunction with the above image analysis. Mixing tank pressure is lowest when flocculation is optimal. The flow rate of the flocculated oil sands tailings cycles inversely with mixing tank pressure.

(4) In the alternative, pressure drop in the flocculated tailings pipeline, as measured by pressure sensor(s) situated on the pipeline, may be used in conjunction with the above image analysis. A low drop in pipeline pressure indicates flocculation is optimal. This monitoring alternative would apply to either tailings that have been flocculated in a mixing tank or flocculated in-line.

(5) If a brightness threshold or other image parameter-based criteria for the image signals, mixing tank pressure, pipeline pressure, or combinations thereof, deviate from predetermined levels or pre-set ranges, an alarm can be subsequently activated to alert the operator to take recovery action. Alternatively an automated response can be programmed into the process.

Thus, broadly stated, in one aspect of the present invention, a process for monitoring dewatering of flocculated oil sands tailings is provided, comprising:
positioning an image capture device in a flow of flocculated oil sands tailing through a pipeline for acquiring one or more images of the flocculated oil sands tailings;
collecting the one or more images of the flocculated oil sands tailings; and
analyzing the one or more images based on brightness, range of image pixel brightness, or other image parameters to ensure production of optimum floc structures for maximum oil sands fine tailings dewatering.

In one embodiment, the image capture device is a camera or other imaging device positioned in the flocculated fluid flow, for example, a particle vision and measurement (PVM) probe.

In one embodiment, the method further comprises positioning at least one pressure sensor in the mixing tank for collecting pressure data over a specific time period.

Additional aspects and advantages of the present invention will be apparent in view of the description, which follows. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will now be described by way of an exemplary embodiment with reference to the accompanying simplified, diagrammatic, not-to-scale drawings:

FIG. 1 shows a schematic of two processes for treating Fluid Fine Tailings.

FIG. 2 shows in situ images of poorly flocculated fluid fine tailings (FFT) and associated threshold of water channels defined by dark pixels, as captured by a camera device.

FIG. 3 shows in situ images of optimally flocculated FFT and associated threshold of water channels defined by dark pixels, as captured by a camera device.

FIG. 4 shows in situ images of flocculated FFT as captured by a camera device, with bright pixels representing flocculated solids.

FIG. 5 shows in situ images of flocculated FFT as captured by an on line camera device and the dewatering capability (Capillary Suction Times (s)).

FIG. 6 shows macroscopic differences in flocculated structure and water release under different mixing conditions.

FIGS. 7-9 show grey scale analyses and microscopic images (insets) of raw FFT image (no flocculant) (FIG. 7), optimally mixed flocculant and FFT (FIG. 8), and over-mixed flocculant and FFT (FIG. 9).

FIG. 10 is a graph showing the relationship between flow rate (m³/hr) and mixing tank pressure (psi).

FIG. 11 is a graph showing the relationship between the acceptance criterion (quantified image analysis, %) and the mixing tank pressure (psi).

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practised without these specific details.

The present invention relates generally to a method for monitoring and controlling dewatering of tailings. As used herein, the term “tailings” means any tailings produced during a mining operation, including tailings derived from oil sands extraction operations, which contain a fines fraction. The term is meant to include fluid fine tailings (FFT) from tailings ponds and fine tailings from ongoing oil sands extraction operations (for example, thickener underflow or froth treatment tailings) which may bypass a tailings pond. As used herein, the term “fine tailings” means tailings that are derived from oil sands extraction operations which contain a fines fraction. Fines are generally defined as solids having a diameter less than 44 microns. The raw FFT will generally have a solids content of around 30 to 40 wt % and may be diluted to about 20-25 wt % with water for use in the present process. However, any oil sands fine tailings having a solids content ranging from about 10 wt % to about 70 wt % or higher can be used.

Useful flocculating polymers or “flocculants” include charged or uncharged polyacrylamides such as a high molecular weight polyacrylamide-sodium polyacrylate co-polymer with about 25-35% anionicity. The polyacrylamide-sodium polyacrylate co-polymers may be branched or linear and have molecular weights which can exceed 20 million.

As used herein, the term “flocculant” refers to a reagent which bridges the neutralized or coagulated particles into larger agglomerates, resulting in more efficient settling. Preferably, the polymeric flocculants are characterized by molecular weights ranging between about 1,000 kD to about 50,000 kD. Natural polymeric flocculants may also be used, for example, polysaccharides such as dextran, starch or guar gum.

Other useful polymeric flocculants can be made by the polymerization of (meth)acrylamide, N-vinyl pyrrolidone, N-vinyl formamide, N,N dimethylacrylamide, N-vinyl acetamide, N-vinylpyridine, N-vinylimidazole, isopropyl acrylamide and polyethylene glycol methacrylate, and one or more anionic monomer(s) such as acrylic acid, methacrylic acid, 2-acrylamido-2-methylpropane sulphonic acid (ATBS) and salts thereof, or one or more cationic monomer(s) such as dimethylaminoethyl acrylate (ADAME), dimethylaminoethyl methacrylate (MADAME), dimethydiallylammonium chloride (DADMAC), acrylamido propyltrimethyl ammonium chloride (APTAC) and/or methacrylamido propyltrimethyl ammonium chloride (MAPTAC).

Various methods for dewatering oil sands tailings include, but are not limited to, in-line dispersion and mixing as disclosed in PCT application WO 2011/032258. WO 2011/032258 describes in-line addition of a flocculant solution into the flow of oil sands fine tailings, including FFT, through a conduit such as a pipeline. A pipeline reactor is disclosed comprising a co-annular injection device for in-line injection of the flocculating liquid within the oil sands fine tailings. Once the flocculant is dispersed into the oil sands fine tailings, the flocculant and fine tailings continue to mix as it travels through the pipeline and the dispersed fine clays bind together (flocculate) to form larger structures (flocs) that can be efficiently separated from the water when ultimately deposited in a deposition area. Other prior art (e.g., Canadian Patent Application No. 2,512,324) suggest addition of water-soluble polymers to oil sands fine tailings during the transfer of the tailings as a fluid to a deposition area, for example, while the tailings are being transferred through a pipeline or conduit to a deposition site.

A stirred tank reactor or dynamic mixer may be used to continuously mix oil sands fine tailings with a water-soluble flocculating polymer, and results in a more consistent production of well-defined floc structures which results in good dewatering as disclosed in Canadian Patent Application No. 2,789,678. Some advantages of using a dynamic mixer include the ability to control the mixing energy input independent of the feed flow rate; it is a more reliable operation; and it results in more robust flocculation performance (i.e., more robust flocs). The ability to control the energy input allows one to obtain the optimal operation regime for floc formation, as above or below the optimal operation regime could result in over-shearing or under-mixing of the mixture of FFT and flocculant solution, both of which result in poor water release. Further, use of a stirred tank reactor allows the operator to control the mixing time (i.e., residence time) of the flocculant to more readily ensure a more robust flocculation performance without over-shearing or under-mixing. The flocculated oil sands fine tailings are removed from the stirred tank reactor and subjected to centrifugation to dewater the oil sands fine tailings and form a high solids cake and a low solids centrate; added to a thickener to dewater the oil sands fine tailings and produce thickened oil sands fine tailings and clarified water; transported to a deposition cell for dewatering; or spread as a thin layer onto a deposition site. It is contemplated that the present invention can be used preferably in conjunction with a stirred tank reactor that can be either a single stage mixer or a multi-stage mixer as disclosed in Canadian Patent Application No. 2,789,678. However, a person skilled in the art would recognize the applicability of this invention to the monitoring and control of any polymer-tailings mixing process.

The present invention relates to a method for monitoring and controlling the dewatering of oil sands tailings, particularly FFT. Proper mixing of the oil sands tailings and flocculant may be monitored in-line to ensure that the flocculated oil sands tailings exhibit the desired properties for successful dewatering. Parameters monitored include visual floc structure, mixing tank pressure, pipeline pressure, and the like. Methods of monitoring include optical probes for particle vision and measurement, and pressure sensors for measuring mixing tank pressure or pipeline pressure. In-line monitoring provides direct real-time observation of key mechanisms in-process and removes the need for off-line analysis and sampling, and eliminates the time-delay associated with off-line analysis. Measuring in-line provides faster process understanding and optimization to improve yield and product quality. Feedback loop control is enabled, with the feedback loop being used to maintain particular parameters at a pre-determined level or within a pre-set range; for example, the flocculant dosage and mixing energy may be adjusted to maintain optimum characteristics of the flocculated oil sands tailings.

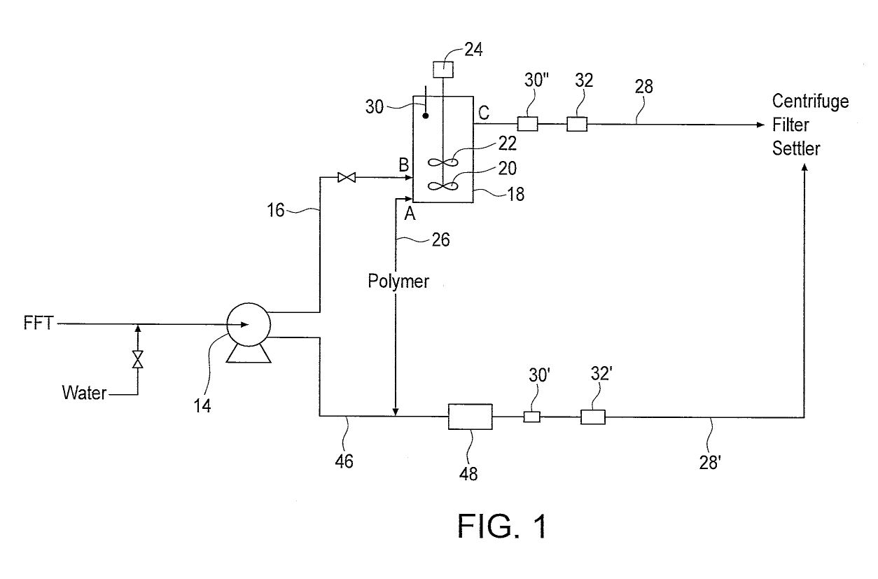

A schematic of two oil sands tailings treatment/dewatering processes using flocculants with which the present invention is utilized is shown in FIG. 1. Useful flocculating polymers include charged or uncharged polyacrylamides such as a high molecular weight polyacrylamide-sodium polyacrylate co-polymer with about 30% anionicity. Other useful polymers include anionic, nonionic and cationic forms of polymerization and copolymerization of sodium acrylate, acryl amide and cationic monomers such as DMAEA (dimethylamino ethyl acrylate), where the molecular weights can exceed 20 million. In one process, oil sands fluid fine tailings, FFT, are dredged from a tailings pond (not shown) and pumped via pump 14 through line 16 and added at Point B of a stirred reactor tank 18. Stirred reactor tank 18 comprises two impellers, lower impeller 20 and upper impeller 22. It is understood that the size, location and number of impellers used in stirred reactor tank is dependent upon the overall dimensions (volume) of the tank. Optionally, FFT can be diluted with water prior to FFT treatment.

A flocculating polymer, such as an aqueous solution of an acrylamide-acrylate copolymer, is added via line 26 to Point A of the stirred reactor tank 18. Generally, the polymer inlet and the FFT inlet are separated spatially, both vertically and horizontally. The impellers 20, 22 are rotated by variable speed motor 24 to give optimum mixing of the FFT and polymer and floc formation. The flocculated FFT is removed near the top of stirred reactor tank 18 at Point C and transferred via flocculated tailings pipeline 28 to a centrifuge, filter, settler, and the like.

A pressure sensor 30 is mounted near the top of the stirred reactor tank 18 to monitor pressure changes in the tank. Additionally, an image capture device 32 is positioned on flocculated tailings pipeline 28 to determine the degree of flocculation of the tailings, as described in more detail below. Alternatively, the pressure drop in the flocculated tailings pipeline 28, which is positioned after the tank, can be used to monitor pressure changes related to the degree of flocculation by using pressure sensor 30″.

In another process, oil sands fluid fine tailings, FFT, are dredged from a tailings pond (not shown) and pumped via pump 14 through pipeline 46. Polymer is added to the FFT in pipeline 46 using, for example, a T-inlet, and the FFT-polymer mixture is further mixed in-line in an in-line mixer such as a static mixer 48 to give optimum mixing of the FFT and polymer and floc formation. In the alternative, FFT and flocculant are mixed via shear in the pipeline itself. In this process, pressure sensor 30′ is mounted to flocculated tailings pipeline 28′ situated downstream of static mixer 48 for measuring pressure drop in pipeline. Additionally, an image capture device 32′ is positioned on flocculated tailings pipeline 28′ downstream of static mixer 48 to determine the degree of flocculation of the tailings, as described in more detail below.

Image capture device is positioned in a flow of flocculated oil sands tailings through the pipeline to allow for the acquisition of one or more images as the pipeline receives a continuous flow of the flocculated oil sands tailings. In one embodiment, the image capture device is a particle vision and measurement (PVM) probe. An exemplary PVM probe according to the present disclosure is commercially available from Mettler-Toledo International Inc. (LASENTEC™, Columbus, Ohio). The PVM probe comprises a high resolution charged coupled device (CCD) camera and internal illumination source. The PVM probe is positioned in the flow through the pipeline at an angle ranging from about 45° to about 90°. In one embodiment, the PVM probe is positioned at an angle of about 45°. It is understood that any position or orientation of the probe which optimizes the image quality or minimizes camera lens contamination can be considered, and it may be advantageous to position the camera to image close to the pipe or vessel wall, or in the centre of the pipe or vessel, depending upon the nature of the mixers being employed.

The camera device is operatively connected to a host computer remote from the camera probe. As used herein, the term “operatively connected” means, in the case of hardware, an electrical connection, for example, wire or cable, for conveying electrical signals, or in the case of firmware or software, a communication link between the processor (which executes the firmware—i.e., operating under stored program control—or software) and another device for transmitting/receiving messages or commands.

The computer may comprise any desktop computer, laptop computer, a handheld or tablet computer, or a personal digital assistant, and is programmed with appropriate software, firmware, a microcontroller, a microprocessor or a plurality of microprocessors, a digital signal processor or other hardware or combination of hardware and software known to those skilled in the art. The computer may be located within a company, possibly connected to a local area network, and connected to the Internet or to another wide area network, or connected to the Internet or other network through a large application service provider. The application software may comprise a program running on the computer, a web service, a web plug-in, or any software running on a specialized device, to enable the images to be processed and analyzed. The computer provides a user interface for monitoring and controlling the flocculation of the oil sands tailings.

The camera probe acquires images of the flocculated oil sands tailings and transmits signals representative of the images to the computer. In one embodiment, the camera probe acquires images at a rate of about 10 images/second. The images from the camera are acquired in real time and immediately transmitted to the computer. It is nevertheless possible for a time offset to remain between the moment the images were acquired and the moment at which the images are transmitted to the computer.

One or more images of the flocculated oil sands tailings are analyzed to ensure production of optimum floc structures for maximum oils sands tailings dewatering. The degree of flocculation is calculated from the images. In one embodiment, the proportion of dark pixels in an image is quantified. As used herein, the term “dark pixels” means pixels ranging from about 0 to about 90 out of a 256 pixel range brightness scale. The dark pixels predominantly represent water channels, but may represent debris or anomalies such as, for example, bitumen, coal, or minerals. A threshold-based image parameter criterion is defined by averaging the percentages of dark pixels from more than one image.

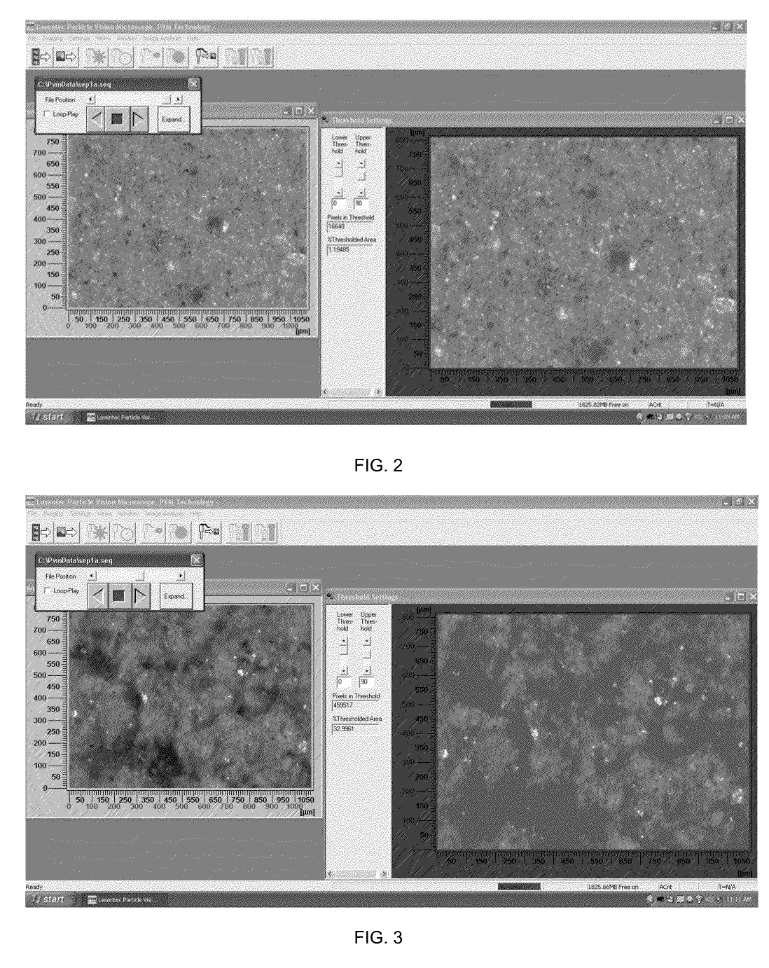

FIG. 2 shows images of poorly flocculated FFT, while FIG. 3 shows images of optimally flocculated FFT. In FIG. 2, it can be seen that the dark pixels represent about 1.2% of the image area, while in FIG. 3, the dark pixels represent about 33.0% of the image area. If the image parameter based criterion is defined as 20% (e.g., a % which can be determined for a particular treated tailings as being the minimum % of dark pixels necessary for reasonable dewatering of that particular sample), FIG. 2 does not meet the criteria, while FIG. 3 meets the image criterion. If twenty images are averaged over a defined time period and at least five images exhibit sufficient water channels to trigger a dark pixel percentage greater than the defined criterion, an acceptance of 25% may be plotted on a graph which can be used as the source of a process monitoring or control narrative. It is understood, however, that the image parameter based criterion will be dependent on a number of factors, for example, the density of the untreated tailings, the camera used, etc.

In one embodiment, the proportion of bright pixels in an image is quantified. As used herein, the term “bright pixels” means pixels ranging from about 105 to about 255 out of a 256 pixel range brightness scale. The bright pixels represent flocculated solids. A threshold-based image parameter criterion is defined by averaging the percentages of bright pixels from more than one image. Quantification of the bright pixels excludes any dark pixels representing debris or anomalies. The definition of an image parameter based criterion follows a similar logic as applied to the dark pixels, but a different threshold level may be more appropriate to define optimal flocculation.

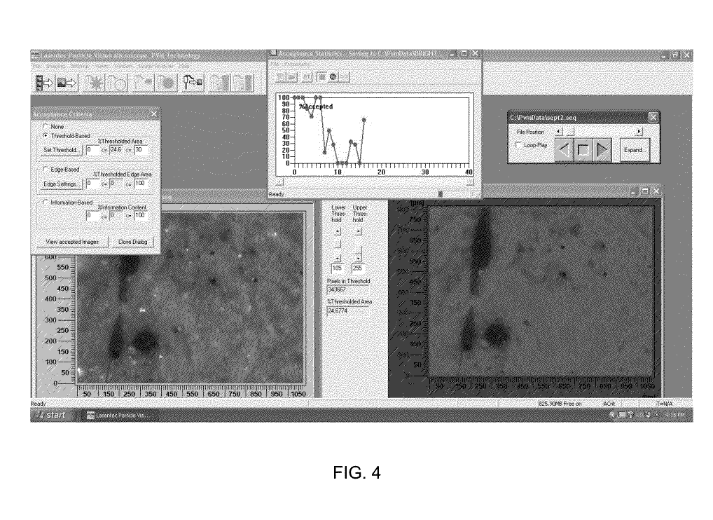

FIG. 4 shows images of flocculated FFT. The bright pixels (as defined above) represent about 25.0% of the image area (see highlighted image on the right). The dark smear represents bitumen contamination on the probe window. The image parameter based criterion graph is also shown (inset, FIG. 4). In this example, image pixels with a brightness or intensity from 105 to 255 are coloured bright pink. In this particular image, these bright pixels represent about 25% of the image area. The threshold for acceptable flocculation in this example is set at 30% of the image area, and the inset in this example shows the results of applying this flocculation criterion to 10 images. If the flocculation or acceptance criteria is 60%, that means that 6 of the 10 images had bright areas in excess of 30% of the total image area. In FIGS. 1 and 2, acceptable flocculation was defined in terms of the percentage of dark pixels in an image. However, if the camera window is prone to bitumen contamination, the percentage of bright pixels might be more appropriate as a process control parameter.

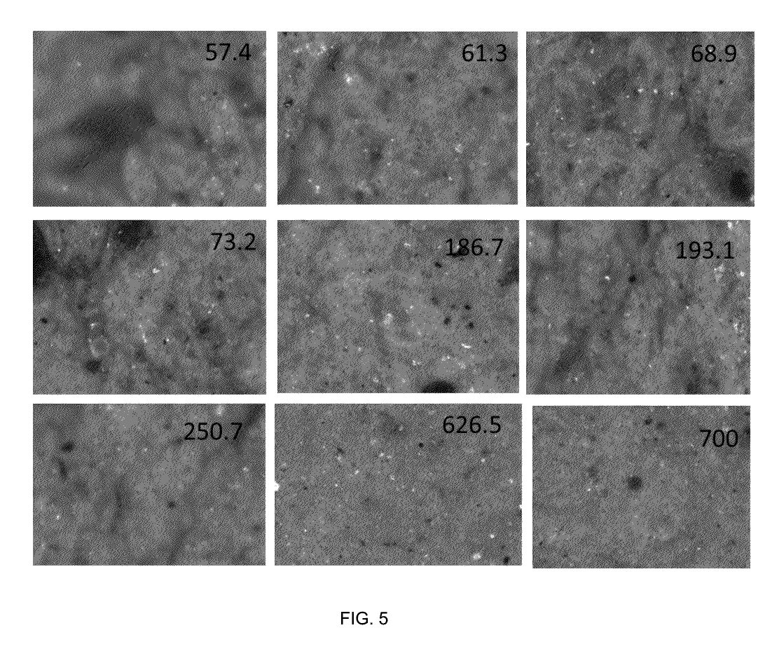

Dewatering capability may be measured using a Triton Electronics Ltd. Capillary Suction Time tester to correlate dewatering efficiency with floc formation. Dewaterability is thus measured as a function of how long it takes for water to be suctioned through a filter and low values indicate rapid dewatering whereas high values indicate slow dewatering ability. Thus, a relatively low CST number indicates good dewatering. Dewatering ability is hereinafter referred to as CST. FIG. 5 confirms a relationship between the degree of flocculation and the CST. The average CST time is shown on each image. It can be seen that there is a general relationship between the degree of flocculation in the image and the average CST number. Each of the CST numbers represents the average of four tests. It can be seen that, starting from the top left, well flocculated tailings have a lower CST number than progressively poorer flocculated tailings (from left to right).

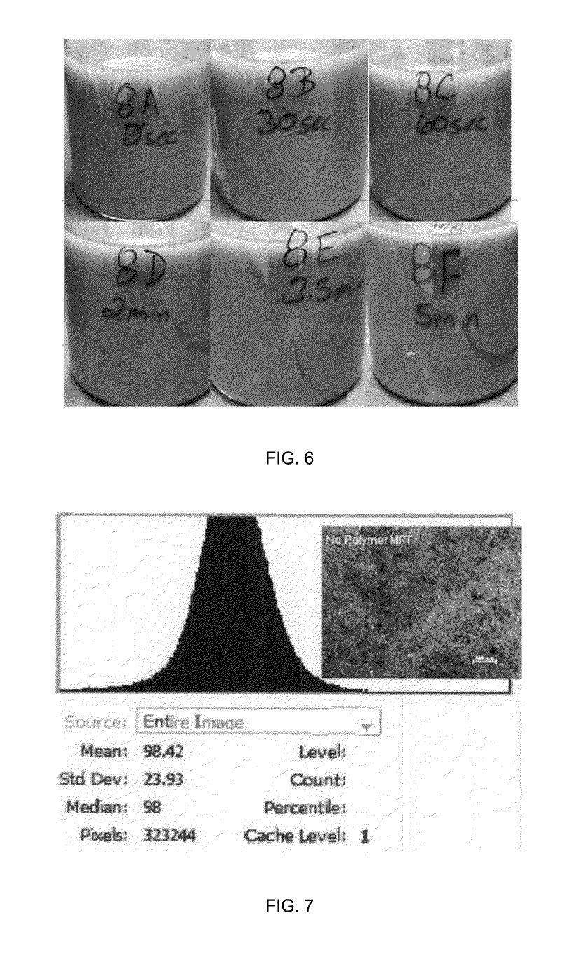

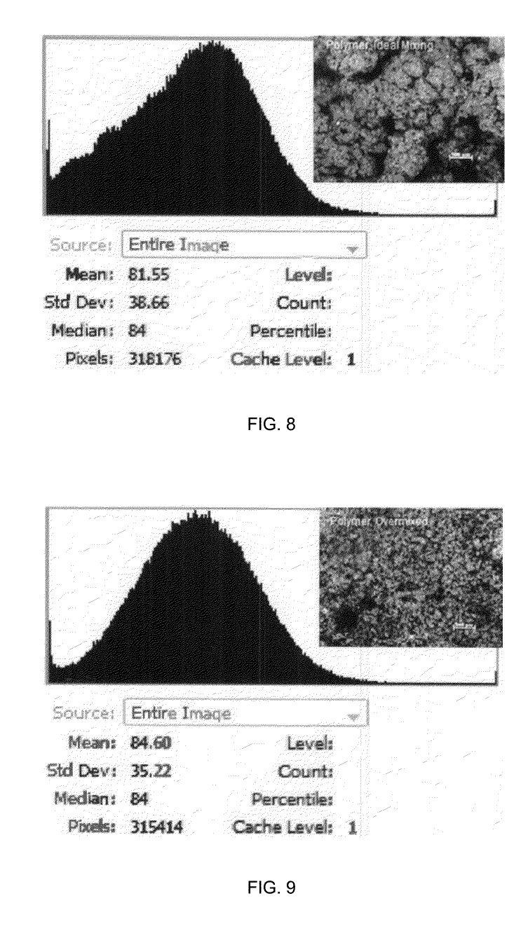

Proper mixing of a flocculant with oil sands tailings is critical to creating the right floc structure that will dewater the tailings rapidly. FIG. 6 shows macroscopic differences in flocculated structure and water release under different mixing conditions. The best mixing can be seen at early times (e.g., 30 seconds), with smaller flocs and less water release at longer mixing times (e.g., 5 minutes). FIGS. 7-9 show grey scale analyses and microscopic images (insets) of raw FFT image (no flocculant) (FIG. 7), optimally mixed flocculant and FFT (FIG. 8), and over-mixed flocculant and FFT (FIG. 9). Optimal mixing results in a fairly well defined floc structure which results in good dewatering. Mixing the flocculant polymer and FFT too vigorously results in floc break down, and poor dewatering. FIGS. 7-9 represent an alternative approach to quantifying the degree of flocculation from the camera images. With poor or no flocculation, the spread of pixel brightness is very narrow, with relatively little variation over an average brightness (see FIG. 7). With optimal flocculation, the floc formation results in significant dark areas, as well as brighter areas. This is shown in FIG. 8, where it can be seen that there is a wide range of pixel brightness with a bias to the lower brightness or dark pixels (representing free water in the camera image). In FIG. 9, with overmixing, the range of pixels is still wide, but with less of a bias towards the darker pixels.

Mixing tank pressure or, in the case of in-line mixing, pipeline pressure, may be used in conjunction with images to monitor and control flocculation of oil sands tailings. At least one pressure sensor may be positioned in an oil sands tailings mixing tank or a pipeline for collecting pressure data over a specific time period. In the case of use of a mixing tank, the pressure sensor is capable of detecting the mixing tank pressure during operation, and outputting and transmitting corresponding pressure signals to a computer. In one embodiment, the mixing tank is a stirred reactor tank. The flocculated oil sands tailings may be removed near the top of the stirred reactor tank for transfer to a centrifuge, thin lift deposition site, a thickener, or accelerated dewatering cell as disclosed in Canadian Patent Application No. 2,789,678. In one embodiment, the pressure sensor is mounted near the top of the stirred reactor tank. In the case of in-line mixing, the pressure sensor is mounted on the pipe in order to detect a drop in pipeline pressure. Low pressure drop indicates well-flocculated tailings, as is described in more detail below. A skilled practitioner would realize that pressure drop would be most efficiently monitored with multiple pressure sensors distributed along the pipeline, but with a pipeline that empties to atmosphere, this can be accomplished with a single sensor.

The pressure sensor is operatively connected to the computer. The pressure sensor generates signals representative of the mixing tank pressure, and transmits the signals to the computer. The signals generated from the pressure sensor are acquired in real time and immediately transmitted to the computer. It is nevertheless possible for a time offset to remain between the moment the pressure is measured and the moment at which the signals are transmitted to the computer, in order to better correlate with the acquisition and averaging of data from the imaging camera.

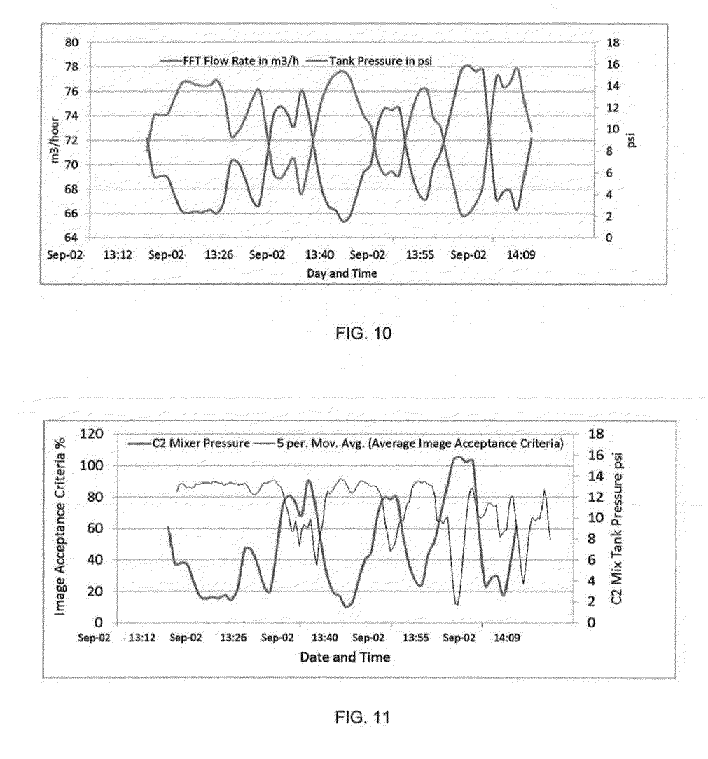

It appears that mixing tank pressure may be correlated with flocculation performance. The mixing tank pressure is lowest when the flocculation is optimal. Without being bound by theory, the correlation of low mixing tank pressure to optimal flocculation may be due to lubrication of the pipe wall with flocculated FFT, resulting in a core-annular flow phenomenon that significantly increases flow with a corresponding decrease in mixing tank pressure. The increase in flow occasionally shifts the process into a less than ideal mixing regime, resulting in poor flocculation and a reduced effect of the water lubricating layer. FIG. 10 shows the cycling of the flow rate inversely with the mixing tank pressure during constant process conditions. The mixing tank pressure cycles as the mixing fluctuates from ideal to poor as the flow rate increases when core annular flow is re-established.

Analysis of the pressure drop fluctuations occurring in the mixing tank discharge pipeline suggests that for some conditions, the flow was lubricated in some parts of the pipeline and not lubricated in other parts of the pipeline. This is consistent with well flocculated FFT undergoing lubricated flow with low pressure drops (low mixing tank pressure) and poorly flocculated FFT with high pressure drops (high mixing tank pressure) flowing with no lubrication. These results indicate that mixing tank pressure is correlated with good flocculation and lubricated flow.

It appears that the performance criteria defined in this case by image brightness (quantified image analysis) may be correlated with mixing tank pressure (FIG. 11). The image based digital data is the average of more than one image where the brightness of the image is used to quantify the degree of flocculation. At high tank pressures, the flocculation is not optimal and there is no water annulus improving flow. This translates to a loss of flocculation which corresponds to a lower threshold, or fewer images with the defined high brightness indications of flocculation. The flocculated FFT appeared to alternate from a lubricated and non-lubricated flow regime in different parts of the pipeline. Therefore, this corresponds to a strong correlation between the direct observation of flocculation via the digital image information (converted to acceptance criterion in FIG. 11) and mixing tank pressure.

Although the degree of flocculation may be quantified by applying image analysis alone, the combination of image analysis data and mixing tank pressure provides a significantly more robust process monitoring and control strategy. If the criteria for the image signals, mixing tank pressure, or both deviate from predetermined levels or pre-set ranges, an alarm can be subsequently activated to alert the operator to take recovery action. The operator may be alerted for example, through a message on the computer or via internet, email, text message, and the like. Recovery may involve adjusting various process parameters including, but not limited to, the flocculant dosage, mixing energy, and the like. The operator may visually assess the flocculated FFT from the images or quickly review mixing tank pressure data to re-establish normal operations. The images and mixing tank pressure data may be collected easily and rapidly from the pipeline for processing and analysis using a single computer. Improvement in monitoring and control of flocculation of oil sands tailings using the present invention thus ensures efficient removal of water from oil sands tailings so that the solids therein can be reclaimed and no longer require residence time in ponds.

From the foregoing description, one skilled in the art can easily ascertain the essential characteristics of this invention, and without departing from the spirit and scope thereof, can make various changes and modifications of the invention to adapt it to various usages and conditions. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A method for monitoring dewatering of flocculated oil sands tailings comprising:
(a) positioning an image capture device in a flow of flocculated oil sands tailing through a pipeline for acquiring one or more images of the flocculated oil sands tailings;
(b) collecting the one or more images of the flocculated oil sands tailings; and
(c) analyzing the one or more images to ensure production of optimum floc structures for maximum oil sands fine tailings dewatering.

2. The method of claim 1, wherein before step (a), the oil sands fine tailings are added as an aqueous slurry to a mixing tank; an effective amount of a polymeric flocculant is added to the mixing tank containing the oil sands fine tailings; and the oil sands fine tailings and polymeric flocculant mixture are mixed for a sufficient time period to form the flocculated oil sands tailings.

3. The method of claim 1, wherein before step (a), the oil sands fine tailings are added as an aqueous slurry to a pipeline; an effective amount of a polymeric flocculant is added to the pipeline containing the oil sands fine tailings; and the oil sands fine tailings and polymeric flocculant mixture are mixed by an inline mixer or by shear in the pipeline for a sufficient time period to form the flocculated oil sands tailings.

4. The method of claim 2, further comprising positioning at least one pressure sensor in the mixing tank, or on the pipeline from the mixing tank for collecting pressure data over a specific time period.

5. The method of claim 4, wherein the pressure sensor is capable of detecting pressure of the flocculated oil sands tailings in the mixing tank during operation, and outputting and transmitting corresponding pressure signals to a computer.

6. The method of claim 5, wherein the image capture device capable of acquiring the one or more images of the flocculated oil sands tailings and transmitting the one or more images to a computer.

7. The method of claim 6, wherein the camera device is positioned in the flow through the pipeline at an angle ranging from about 45° to about 90°.

8. The method of claim 7, wherein the camera device is positioned at an angle of about 45°.

9. The method of claim 7, wherein the camera device acquires images at a rate of about 10 images/second.

10. The method of claim 6, wherein the camera and the pressure sensor are operatively connected to a host computer, the computer being programmed to process and analyze image signals from the camera and pressure signals from the pressure sensor.

11. The method of claim 10, further comprising quantifying the proportion of dark pixels in the one or more images, the dark pixels representing water channels or debris.

12. The method of claim 11, further comprising defining threshold-based criterion by averaging the percentages of dark pixels from more than one image.

13. The method of claim 12, wherein the dark pixels range from about 0 to about 90 out of a 256 pixel range brightness scale.

14. The method of claim 10, further comprising quantifying the proportion of bright pixels in the one or more images, the bright pixels representing flocculated solids.

15. The method of claim 14, further comprising defining threshold-based criterion by averaging the percentages of bright pixels from more than one image.

16. The method of claim 15, wherein the bright pixels range from about 105 to about 225 out of a 256 pixel range brightness scale.

17. The method of claim 10, further comprising activating an alert upon determination that the image signals, the pressure signals, or both deviate from predetermined levels or pre-set ranges.

18. The method of claim 1, wherein the oil sands tailings are fluid fine tailings.

19. The method of claim 2, wherein the oil sands mixing tank is a stirred tank reactor.

20. The method of claim 3, further comprising positioning at least one pressure sensor on the pipeline for collecting pressure data over a specific time period.

21. The method of claim 20, wherein the pressure sensor is capable of detecting a pressure drop of the pipeline and outputting and transmitting corresponding pressure signals to a computer.

22. The method of claim 21, wherein the image capture device capable of acquiring the one or more images of the flocculated oil sands tailings and transmitting the one or more images to a computer.

23. The method of claim 22, wherein the camera device is positioned in the flow through the pipeline at an angle ranging from about 45° to about 90°.

24. The method of claim 22, wherein the camera device is positioned at an angle of about 45°.

25. The method of claim 22, wherein the camera device acquires images at a rate of about 10 images/second.

26. The method of claim 21, wherein the camera and the pressure sensor are operatively connected to a host computer, the computer being programmed to process and analyze image signals from the camera and pressure signals from the pressure sensor.

27. The method of claim 26, further comprising quantifying the proportion of dark pixels in the one or more images, the dark pixels representing water channels or debris.

28. The method of claim 27, further comprising defining threshold-based criterion by averaging the percentages of dark pixels from more than one image.

29. The method of claim 28, wherein the dark pixels range from about 0 to about 90 out of a 256 pixel range brightness scale.

30. The method of claim 26, further comprising quantifying the proportion of bright pixels in the one or more images, the bright pixels representing flocculated solids.

31. The method of claim 30, further comprising defining threshold-based criterion by averaging the percentages of bright pixels from more than one image.

32. The method of claim 26, wherein the bright pixels range from about 105 to about 225 out of a 256 pixel range brightness scale.

33. The method of claim 26, further comprising activating an alert upon determination that the image signals, the pressure signals, or both deviate from predetermined levels or pre-set ranges.
